(19) United States
(12) Patent Application Publication
(10) Pub. No.: US 2005/0225705 A1
(43) Pub. Date: Oct. 13, 2005

(54) Liquid crystal display device having bilateral display function

(75) Inventors: Hye Kyung Chae, Gyeongsangnam-do (KR); Jeong Ha Lee, Kyoungki-do (KR)

Correspondence Address: SEYFARTH SHAW, 55 EAST MONROE STREET, SUITE 4200, CHICAGO, IL, 60603-5803, US

(73) Assignee: Boe Hydis Technology Co., Ltd.

(21) Appl. No.: 11/100,055

(22) Filed: Apr. 6, 2005

(30) Foreign Application Priority Data
Apr. 8, 2004 (KR) 10-2004-0024144
Nov. 1, 2004 (KR) 10-2004-0087993

(51) Int. Cl. G02F 1/1345

(52) U.S. Cl. 349/114

(57) ABSTRACT

Disclosed is a liquid crystal display device having a bilateral display function. The liquid crystal display device includes a first substrate formed with a thin film transistor array and including a plurality of first transmissive parts and a plurality of first reflective parts aligned between the first transmissive parts, and a second substrate formed with a color filter array and including a plurality of second reflective parts and a plurality of second transmissive parts aligned between the second reflective parts. The light passes through the first substrate and is reflected from the second reflective parts of the second substrate so that the light is visually detected at a backside of the thin film transistor. The light is reflected from the first reflective parts of the first substrate so that the light is visually detected at a backside of the color filter array.

### BACKGROUND OF THE INVENTION

1. Field of the Invention

The present invention relates to a reflective type liquid crystal display device, and more particularly to a liquid crystal display device in which an array substrate is combined with a color filter substrate in order to obtain a bilateral display function.

2. Description of the Prior Art

A conventional liquid crystal display device includes a thin film transistor array substrate for driving liquid crystal and a color filter substrate for obtaining a color-image. In a case of a transmissive type liquid crystal display device, a backlight unit is added as a light source in a backside of the liquid crystal display. The thin film transistor array substrate drives the liquid crystal according to a data signal applied thereto and the color substrate allows light to have a color after the light has passed through the color substrate. In addition, the light radiated from the backlight unit is visually detected after the light has sequentially passed through the thin film transistor array substrate, the liquid crystal, and the color substrate. Thus, a person may view an image only from a front of the liquid crystal display device due to the arrangement of the backlight unit.

That is, in a case of the transmissive type liquid crystal display device, in which the thin film transistor array substrate and the color substrate are integrated on mutually different glasses, the person may view the light radiated from the backlight unit after the light has passed through a panel assembly, so that the image is displayed only at one side of the transmissive type liquid crystal display device due to the arrangement of the backlight unit.

In order to solve the above problem, Korean Laid-Open Patent Publication No. 2003-0051011 discloses a liquid crystal display device having a bilateral display function.

FIGS. 1 and 2 are plan and sectional views illustrating first and second substrates of the conventional liquid crystal display device having the bilateral display function disclosed in Korean Laid-Open Patent Publication No. 2003-0051011.

As shown in FIGS. 1 and 2, the conventional liquid crystal display device includes a first substrate 1 formed with a first thin film transistor array 2 and a first color filter array 3, a second substrate 10 formed with a second color filter array 13 facing the first thin film transistor array 2 and a second thin film transistor array 12 facing the first color filter array 3, and liquid crystal (not shown) interposed between the first and second substrates 1 and 2.

Signal wirings of data lines and gate lines are formed on the first thin film transistor array 2 of the first substrate 1 and the second thin film transistor array 12 of the second substrate 2, respectively. In addition, a thin film transistor is formed at cross points between the data lines and gate lines.

A first black matrix 4 of the first substrate 1 prevents light leakage between the first thin film transistor array 2 and the first color filter array 3. In addition, a second black matrix 14 of the second substrate 10 prevents light leakage between the second color filter array 13 and the second thin film transistor array 12.

A first pad area 5 is formed at one side of the first substrate 1 and a second pad area 15 is formed on one side of the second substrate 10 in such a manner that the first and second pad areas 5 and 15 are connected to the data lines and gate lines of the first and second thin film transistor arrays 2 and 12, respectively. The first and second pad areas 5 and 15 feed data signals and scan signals of a driving circuit (not shown) to the data lines and gate lines, respectively.

In addition, as shown in FIG. 2, a first backlight unit 20 is aligned at a backside of the first thin film transistor array 2 of the first substrate 1 and a second backlight unit 21 is aligned at a backside of the second thin film transistor array 12 of the second substrate 2, respectively.

The data signals and scan signals are fed to the first and second thin film transistor arrays 2 and 12 from the driving circuit through the first and second pad areas 5 and 15.

Therefore, the data signal fed to the first thin film transistor array 2 is displayed in a first direction through the second color filter array 13 according to the light radiated from the first backlight unit 20 while adjusting an amount of the light beam passing through the liquid crystal layer and the data signal fed to the second transistor array 12 is displayed in a second direction through the first color filter array 3 according to the light radiated from the second backlight unit 21.

However, the conventional liquid crystal display device does not display a full-sized image, but display a half-sized image at front and rear portions of the conventional liquid crystal display device, respectively.

### SUMMARY OF THE INVENTION

Accordingly, the present invention has been made to solve the above-mentioned problems occurring in the prior art, and an object of the present invention is to provide a liquid crystal display device having a bilateral display function, in which two array glasses are combined with each other in such a manner that the two array glasses may share and drive one liquid crystal section, thereby displaying a full-sized image at front and rear portions of the liquid crystal display device, respectively.

Another object of the present invention is to provide a liquid crystal display device having a bilateral display function, in which a first substrate formed with a thin film transistor array is combined with a second substrate formed with a color filter array in such a manner that the first and second substrates may share one liquid crystal section, thereby bilaterally displaying a full-sized image, and which can be driven through the FFS or IPS scheme and can be operated with the TN, VVA, MVA or ASV mode.

In order to accomplish these objects, according to a first aspect of the present invention, there is provided a liquid crystal display device having a bilateral display function, the liquid crystal display device comprising: a first substrate including a plurality of first transmissive parts for allowing a first direction incident light to pass therethrough, and a plurality of first reflective parts aligned between the first transmissive parts; and a second substrate including a plurality of second reflective parts aligned in opposition to the first transmissive parts in order to reflect the first direction incident light, and a plurality of second transmissive parts aligned between the second reflective parts in opposition to the first reflective parts in order to allow a second direction incident light, which has been reflected from the first reflective parts, to pass therethrough.

Each of the first and second transmissive parts includes a gate insulation layer and a protective layer, which are sequentially formed on a glass substrate.

Each of the first and second reflective parts includes a gate insulation layer formed on a glass substrate, a protective layer formed on the gate insulation layer, a reflective layer formed on the protective layer in order to reflect the light which has passed through the first and second transmissive parts, a color filter resin layer formed on the reflective layer in order to represent one of red, green and blue colors, and a pixel electrode formed on the color filter resin layer.

A first pad area is formed at one side of the first substrate in order to feed a first driving signal to the first substrate and a second pad area is formed at one side of the second substrate in order to feed a second driving signal to the second substrate.

According to a second aspect of the present invention, there is provided a liquid crystal display device having a bilateral display function, the liquid crystal display device comprising: a first substrate including a plurality of first transmissive parts and a plurality of second transmissive parts aligned between the first transmissive parts; and a second substrate including a plurality of third transmissive parts aligned in opposition to the first transmissive parts in order to allow an incident light, which has passed through the first transmissive parts, to pass therethrough and a plurality of first reflective parts aligned between the third transmissive parts in order to reflect an incident light, which has passed through the second transmissive parts.

Each of the first transmissive parts includes a gate insulation layer, a protective layer and a pixel electrode, which are sequentially formed on a glass substrate.

Each of the second transmissive parts includes a gate insulation layer and a protective layer, which are sequentially formed on a glass substrate.

Each of the third transmissive parts includes a gate insulation layer, a protective layer, and a color filter resin layer, which are sequentially formed on a glass substrate.

Each of the first reflective parts includes a gate insulation layer formed on a glass substrate, a protective layer formed on the gate insulation layer, a resin layer formed on the protective layer in such a manner that a cell gap formed between the first reflective part and the second transmissive part is about ½ of a cell gap formed between the first transmissive part and the third transmissive part, a reflective layer formed on the protective layer in order to reflect the light which has passed through the second transmissive parts, a color filter resin layer formed on the reflective layer in order to represent one of red, green and blue colors, and a pixel electrode formed on the color filter resin layer.

According to a third aspect of the present invention, there is provided a liquid crystal display device having a bilateral display function, the liquid crystal display device comprising: a first substrate formed with a thin film transistor array and including a plurality of first transmissive parts and a plurality of first reflective parts aligned between the first transmissive parts and a second substrate formed with a color filter array and including a plurality of second reflective parts aligned in opposition to the first transmissive parts and a plurality of second transmissive parts aligned between the second reflective parts in opposition to the first reflective parts wherein a first light incident from a first direction passes through the first transmissive parts of the first substrate and is reflected from the second reflective parts of the second substrate in such a manner that the first light is visually detected at a backside of the thin film transistor of the first substrate, and a second light incident from a second opposite direction passes through the second transmissive parts of the second substrate and is reflected from the first reflective parts of the first substrate in such a manner that the second light is visually detected at a backside of the color filter array of the second substrate.

Each of the first transmissive parts includes a gate insulation layer, a protective layer, and a pixel electrode, which are sequentially formed on the first substrate, and each of the first reflective parts includes a gate insulation layer, a first reflective plate, a protective layer, and a pixel electrode, which are sequentially formed on the first substrate. The first reflective plate is patterned on a same layer of a source/drain electrode of the thin film transistor array.

The second transmissive part includes a color filter resin layer and a common electrode, which are sequentially formed on the second substrate, and the second reflective part includes a second reflective plate, a color filter resin layer and a common electrode, which are sequentially formed on the second substrate.

A backside of the thin film transistor array of the first substrate and a backside of the color filter array of the second substrate act such that a same image or mutually different images are bilaterally displayed. When the same image is bilaterally displayed, a data signal fed into a first data line of the first substrate is identical to a data signal fed into a final data line of the first substrate.

A first light source is positioned at a backside of the thin film transistor array of the first substrate, and a second light source is positioned at a backside of the color filter array of the second substrate. The first and second light sources include one selected from the group consisting of an LED, an EEFL and a CCFL.

According to a fourth aspect of the present invention, there is provided a liquid crystal display device having a bilateral display function, the liquid crystal display device comprising: a first substrate formed with a thin film transistor array and including a transmissive transistor array for allowing a first directional light to pass therethrough, and a reflective transistor array for reflecting a second directional light incident thereon; and a second substrate formed with a color filter array and including a reflective color filter array positioned corresponding to the transmissive transistor array in order to reflect the first directional light, which has passed through the transmissive transistor array, and a transmissive color filter array positioned corresponding to the reflective transistor array in order to allow and the light reflected from the reflective transistor array to pass therethrough.

Each of the reflective transistors in array is sequentially aligned in column of the first substrate and is alternately positioned with the adjacent transmissive transistor in row of the first substrate, and each of the reflective color filters in array is sequentially aligned in column of the second substrate and is alternately positioned with the adjacent transmissive color filter in row of the second substrate.

Each of the reflective transistors is alternately aligned with the adjacent transmissive transistor in column and row of the first substrate and each of the reflective color filters is alternately aligned with the adjacent transmissive color filters in column and row of the second substrate.

The reflective transistor array is aligned in opposition to the transmissive color filter array and the reflective color filter array is aligned in opposition to the transmissive transistor array when the first substrate faces the second substrate.

### BRIEF DESCRIPTION OF THE DRAWINGS

The above and other objects, features and advantages of the present invention will be more apparent from the following detailed description taken in conjunction with the accompanying drawings, in which:

FIGS. 1 and 2 are plan and sectional views illustrating first and second substrates of a conventional liquid crystal display device having a bilateral display function disclosed in Korean Laid-Open Patent Publication No. 2003-0051011;

FIG. 3 is a plan view illustrating first and second substrates of a liquid crystal display device having a bilateral display function according to a first embodiment of the present invention;

FIG. 4 is a sectional view illustrating a structure of a liquid crystal display device having a bilateral display function according to a first embodiment of the present invention;

FIG. 5 is a plan view illustrating first and second substrates of a liquid crystal display device having a bilateral display function according to a second embodiment of the present invention;

FIG. 6 is a sectional view illustrating a structure of a liquid crystal display device having a bilateral display function according to a second embodiment of the present invention;

FIG. 7 is a sectional view illustrating an operational principle of a liquid crystal display device having a bilateral display function according to a third embodiment of the present invention;

FIGS. 8 and 9 are plan and sectional views illustrating first and second substrates of a liquid crystal display device having a bilateral display function according to a third embodiment of the present invention; and

FIG. 10 is a plan view illustrating first and second substrates of a liquid crystal display device having a bilateral display function according to a fourth embodiment of the present invention.

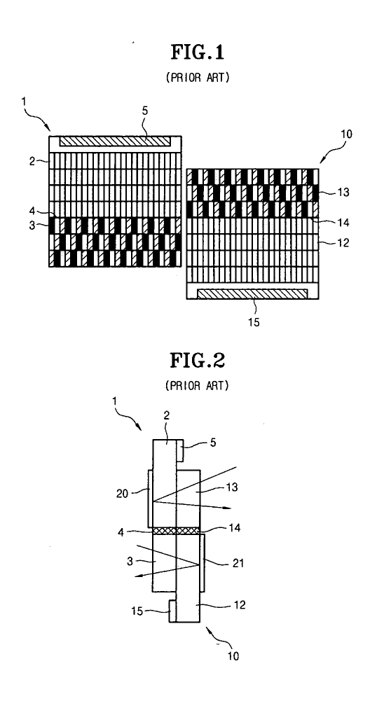

### DETAILED DESCRIPTION OF THE PREFERRED EMBODIMENTS

Hereinafter, the preferred embodiment of the present invention will be described with reference to accompanying drawings.

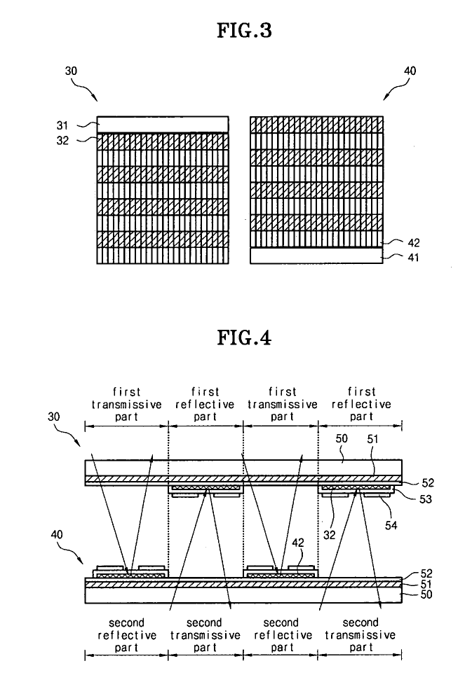

FIG. 3 is a plan view illustrating first and second substrates of a liquid crystal display device having a bilateral display function according to a first embodiment of the present invention, and FIG. 4 is a sectional view illustrating a structure of the liquid crystal display device having the bilateral display function according to the first embodiment of the present invention.

As shown in FIG. 3, the liquid crystal display device according to the first embodiment of the present invention includes a first substrate 30, a second substrate 40, a first pad area 31, and a second pad area 41.

As shown in FIG. 4, the first substrate 30 includes a plurality of first transmissive parts allowing incident light to pass therethrough and a plurality of reflective parts aligned between the first transmissive parts in order to reflect the light.

In addition, the second substrate 40 includes a plurality of second reflective parts aligned in opposition to the first transmissive parts in order to reflect the light, which has passed through the first transmissive parts, and a plurality of second transmissive parts aligned between the second reflective parts in opposition to the first reflective parts in order to allow the light reflected from the first reflective parts.

Each of the first and second transmissive parts includes a gate insulation layer 51 and a protective layer 52, which are sequentially formed on a glass substrate 50. Herein, the first substrate 30 or the second substrate 40 signifies a main substrate, which is different from the glass substrate 50.

In addition, each of the first and second reflective parts includes the gate insulation layer 51 formed on the glass substrate 50, the protective layer 52 formed on the gate insulation layer 51, a reflective plate 32 or 42 formed on the protective layer 52 in order to reflect the light, which has passed through the first and second transmissive parts, a color filter resin layer 53 formed on the reflective plate 32 or 42 in order to represent one of red, green, and blue colors, and a pixel electrode 54 formed on the color filter resin layer 53. Herein, the reflective plate 32 or 42 is a common electrode capable of reflecting the light, which has passed through the transmissive parts.

In the meantime, the first pad area 31 is formed at one side of the first substrate 30 so as to feed a first driving signal, and the second pad area 41 is formed at one side of the second substrate 40 so as to feed a second driving signal.

According to the first embodiment of the present invention, the liquid crystal display device includes the first substrate 30, which is an array glass capable of driving liquid crystal in such a manner that the light is visually detected at a front of the liquid crystal display device, and the second substrate 40, which is an array glass capable of driving liquid crystal in such a manner that the light is visually detected at a rear of the liquid crystal display device.

In addition, pixel structures of the array glasses are divided into a reflective unit (first and second reflective parts) and a transmissive unit (first and second transmissive parts) in order to bilaterally display the image. Thus, the ITO electrodes are not formed over the whole area of the pixels, but the ITO electrodes are formed only on the first and second reflective parts adjacent to the thin film transistor in order to drive the pixels while allowing the first and second transmissive parts to transmit the light therethrough.

In order to display mutually different images at the front and rear portions of the liquid crystal display device, the liquid crystal must be bilaterally driven in one pixel structure. Thus, a half of the liquid crystal is driven by one array substrate (that is, the first substrate 30) provided at one side of the liquid crystal display device and the remaining half of the liquid crystal is driven by the other array substrate (that is, the second substrate 40) provided at the other side of the liquid crystal display device. That is, the liquid crystal is retained at both sides of the liquid crystal display device by means of two array substrates. As a result, the two array substrates share the liquid crystal so that the mutually different images are bilaterally displayed in the liquid crystal display device.

According to the first embodiment of the present invention, since two array glasses are combined with each other, the ITO electrodes are not formed in the array glasses. Thus, the liquid crystal display device is driven through the FFS or IPS scheme by using a twist angle of the liquid crystal instead of using a tilt angle of the liquid crystal. In addition, when performing 5-mask processes for the reflective type liquid crystal display device, processes for forming a reflective plate and a color filter mask of a color filter substrate must be carried out in addition to the processes for forming a gate, an active layer, a source/drain, a protective layer, and an ITO layer. However, according to the present invention, the above processes can be replaced with the processes for forming a gate, an active layer, a source/drain, a color resin layer, and a transparent common ITO electrode.

That is, although the conventional reflective type liquid crystal display device requires the process of a reflective layer mask, according to the present invention, the source/drain metal is used as a reflective layer so that the process of the reflective layer mask can be omitted. In addition, the liquid crystal display device according to the present invention can be formed with a structure including a gate, an active layer, a source/drain, a reflective layer, a color resin layer, and a transparent ITO layer (pixel electrode or common electrode).

According to the present invention, since a color filter resin layer 610 is integrated on two array substrates, which are combined with each other, through a color filter on array (COA) scheme without using a color filter substrate, a high aperture rate can be obtained.

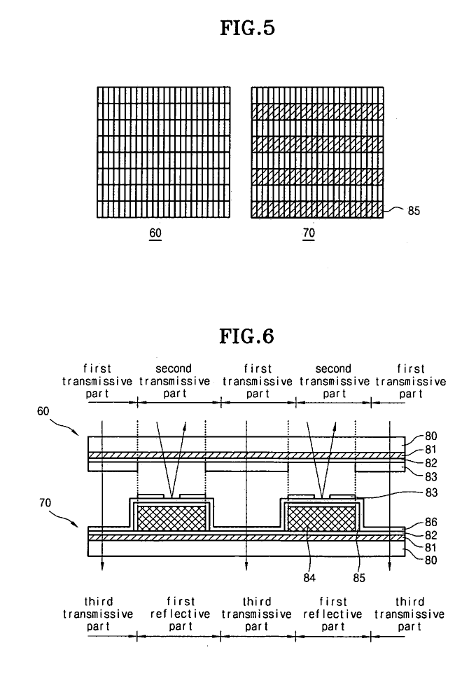

FIG. 5 is a plan view illustrating first and second substrates of a liquid crystal display device having a bilateral display function according to a second embodiment of the present invention, and FIG. 6 is a sectional view illustrating a structure of the liquid crystal display device having the bilateral display function according to the second embodiment of the present invention.

As shown in FIGS. 5 and 5, the liquid crystal display device according to the second embodiment of the present invention includes a first substrate 60 and a second substrate 70.

The first substrate 60 has a plurality of first transmissive parts for allowing a first incident light to pass therethrough and a plurality of second transmissive parts aligned between the first transmissive parts in order to allow a second incident light to pass therethrough.

The second substrate 70 has a plurality of third transmissive parts aligned in opposition to the first transmissive parts in order to allow the first incident light, which has passed through the first transmissive parts, to pass therethrough in one direction, and a plurality of first reflective parts aligned between the third transmissive parts in order to reflect the second incident light, which has passed through the second transmissive parts.

Each of the first transmissive parts includes a gate insulation layer 81, a protective layer 82, and a pixel electrode 83, which are sequentially formed on a glass substrate 80. In addition, each of the second transmissive parts includes the gate insulation layer 81 and the protective layer 82, which are sequentially formed on the glass substrate 80.

Each of the third transmissive parts includes the gate insulation layer 81, the protective layer 82, and a color filter resin layer 86, which are sequentially formed on the glass substrate 80. In addition, each of the first reflective parts includes the gate insulation layer 81 formed on the glass substrate 80, the protective layer 82 formed on the gate insulation layer 81, a resin layer 84 formed on the protective layer 82 in such a manner that a cell gap formed between the first reflective part and the second transmissive part is about ½ of a cell gap formed between the first transmissive part and the third transmissive part, a reflective layer 85 formed on the protective layer 82 in order to reflect the light which has passed through the third transmissive parts, a color filter resin layer 86 formed on the reflective layer 85 in order to represent one of red, green and blue colors, and a pixel electrode 93 formed on the color filter resin layer 86.

In addition, the first and second substrates share the liquid crystal and the liquid crystal is driven through the FFS or IPS scheme. A transflective liquid crystal display device having a bilateral display function has an advantage in that it can be operated in both transmissive mode and reflective mode and it can be easily fabricated by forming a color filter resin layer on one substrate. In addition, the image can be bilaterally displayed through the liquid crystal display device even if one light unit is attached to only one surface of the liquid crystal display device.

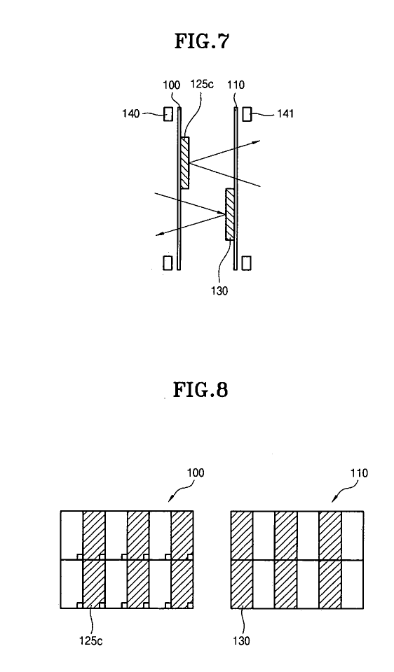

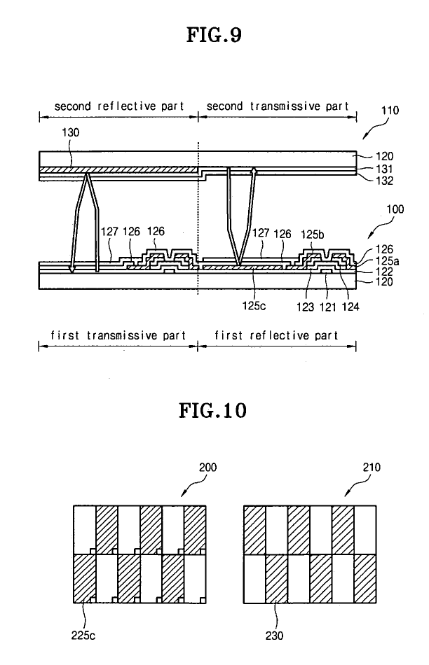

FIG. 7 is a sectional view illustrating an operational principle of a liquid crystal display device having a bilateral display function according to a third embodiment of the present invention, and FIGS. 8 and 9 are plan and sectional views illustrating first and second substrates of the liquid crystal display device having the bilateral display function according to the third embodiment of the present invention.

Hereinafter, the liquid crystal display device having the bilateral display function according to the third embodiment of the present invention will be described with reference to FIGS. 7 to 9.

The liquid crystal display device having the bilateral display function according to the third embodiment of the present invention includes a first substrate 100, a second substrate 110, a first reflective plate 125c, and a second reflective plate 130.

The first substrate 100 is formed with a thin film transistor array and has a plurality of first transmissive parts for allowing an incident light to pass therethrough and a plurality of first reflective parts aligned between the first transmissive parts in order to reflect the incident light. Herein, each of the first reflective part includes a first reflective plate 125c having a reflective function.

In addition, the second substrate 110 is formed with a color filter array and has a plurality of second reflective parts aligned in opposition to the first transmissive parts in order to reflect the light, which has passed through the first transmissive parts, and a plurality of second transmissive parts aligned between the second reflective parts in opposition to the first reflective parts in order to allow the light reflected from the first reflective parts to pass therethrough. Herein, each of the second reflective part includes a second reflective plate 130 having a reflective function.

As shown in FIG. 8, the first reflective parts having the first reflective plates 125c are sequentially aligned on the first substrate 100 along a first direction in such a manner that the first reflective parts are alternately aligned with the first transmissive parts, which are sequentially aligned in a second direction perpendicularly to the first direction. In the same manner, the second reflective parts having the second reflective plates 130 are sequentially aligned on the second substrate 110 along the first direction in such a manner that the first reflective parts are alternately aligned with the second transmissive parts, which are sequentially aligned in the second direction perpendicularly to the first direction. In addition, the first reflective parts are aligned in opposition to the second transmissive parts when the first substrate faces the second substrate. In the same manner, the second reflective parts are aligned in opposition to the first transmissive parts when the first substrate faces the second substrate.

According to the third embodiment of the present invention, in order to bilaterally display the image, a pixel electrode 127 of the first substrate 100 faces the second reflective plate 130 of the second substrate 110 and the first reflective plate 125c of the first substrate 100 faces a common electrode 132 of the second substrate 110. In addition, the first reflective part may cooperate with the first transmissive part and the second reflective part may cooperate with the second transmissive part in order to bilaterally display the image.

In the first substrate 100, a gate insulation layer 122, a protective layer 126, and a pixel electrode 127 are sequentially formed on a glass substrate 120 of the first transmissive part. In addition, the gate insulation layer 122, the first reflective plate 125c, the protective layer 126, and the pixel electrode 127 are sequentially formed on the glass substrate 120 of the first reflective part. Herein, the first substrate signifies a main substrate having the above structure and is different from the glass substrate 120.

When performing 5-mask processes for the reflective type liquid crystal display device, a process of the reflective plate mask must be carried out in addition to the processes for forming a gate electrode, an active layer, a source/drain, a protective layer, and a pixel electrode. However, according to the third embodiment of the present invention, the above processes can be replaced with the processes for forming a gate electrode 121, an active layer 123, source/drain electrodes 125a and 125b, a first reflective plate 125c, a protective layer 126 and a pixel electrode 127. That is, when fabricating a thin film transistor, the reflective plate 125c is patterned when the source/drain electrodes 125a and 125b are formed so that it is possible to omit the process of the reflective plate mask. Although it is not illustrate in figures, a pixel electrode can be used as the first reflective plate. In this case, an opaque conductive metal layer, instead of an indium tin oxide (ITO), is used as a metal layer for forming the pixel electrode of the first reflective part.

In addition, in the second substrate 110, a color filter resin layer 131 for representing one of red, green and blue colors and the common electrode 132 are sequentially formed on the glass substrate 120 of the second transmissive part. In addition, the second reflective plate 130, the color filter resin layer 131 and the common electrode 132 are sequentially formed on the glass substrate 120 of the second reflective part. Although it is not illustrate in figures, a common electrode can be used as the second reflective plate 130. In this case, an opaque conductive metal layer, instead of an indium tin oxide (ITO), is used as a metal layer for forming the common electrode of the second reflective part.

According to the present invention, a first pixel consisting of the first reflective part and the second transmissive part may cooperate with a second pixel consisting of the first transmissive part and the second reflective part in order to bilaterally display the image. Accordingly, the image is displayed in the direction of the second substrate when using the thin film transistor of the first reflective part, and the image is displayed in the direction of the first substrate when using the thin film transistor of the first transmissive part.

In addition, a first light source 140 having a backlight function is aligned at a backside of the thin film transistor array of the first substrate 100 and a second light source 141 having a backlight function is aligned at a backside of the color filter array of the second substrate 110. At this time, the light sources 140 and 141 may include an LED, an EEFL, or a CCFL.

In the pixel unit according to the third embodiment of the present invention, pixel structures (two pixels) of adjacent dots are formed differently from each other in order to bilaterally display the image. Such a structure may form a bilateral reflection path of the light. For instance, a first light incident along one direction passes through the second substrate and is reflected from the reflective plate of the first substrate. In contrast, a second light incident along the other direction opposite to the first light passes through the first substrate and is reflected from the second reflective plate of the second substrate so that the light is visually detected by the person.

In the meantime, the backside of the thin film transistor array of the first substrate 100 and the backside of the color filter array of the second substrate 110 may act in such a manner that the same image can be bilaterally displayed or mutually different images can be bilaterally displayed. In order to allow the same image to be bilaterally displayed, the data signal inputted into a first data line of the first substrate must be identical to the data signal inputted into a final data line of the first substrate. Accordingly, if the first data signal is visually detected at the backside of the thin film transistor array of the first substrate, the same image can be visually detected at the backside of the color filter array of the second substrate 110 through an address for the final data signal.

In addition, in order to bilaterally display the mutually different images, different data signals must be inputted into the first and final data lines.

FIG. 10 is a plan view illustrating first and second substrates of a liquid crystal display device having a bilateral display function according to a fourth embodiment of the present invention.

The liquid crystal display device having the bilateral display function according to the fourth embodiment of the present invention is substantially identical to the liquid crystal display device according to the first embodiment of the present invention except for an alignment order of the first reflective parts, the first transmissive parts, the second reflective parts, and the second transmissive parts.

That is, first reflective parts including first reflective plates 225c and first transmissive parts are alternately aligned on a first substrate 200 along horizontal and longitudinal directions of the first substrate 200. In addition, second reflective parts including second reflective plates 230 and second transmissive parts are alternately aligned on a second substrate 210 along horizontal and longitudinal directions of the second substrate 210. The first reflective parts including the first reflective plates 225c are aligned in opposition to the second transmissive parts when the first substrate faces the second substrate. In the same manner, the second reflective parts including the second reflective plates 230 are aligned in opposition to the first transmissive parts when the first substrate faces the second substrate.

Similarly to the third embodiment of the present invention, in the pixel unit according to the fourth embodiment of the present invention, pixel structures (two pixels) of adjacent dots are formed differently from each other in order to bilaterally display the image. Such a structure may form a bilateral reflection path of the light. Accordingly, the backside of the thin film transistor array of the first substrate 200 and the backside of the color filter array of the second substrate 210 may act in such a manner that the same image can be bilaterally displayed or mutually different images can be bilaterally displayed.

As described above, according to the present invention, two array glasses combined with each other may share the liquid crystal so that the liquid crystal display device of the present invention can bilaterally display the image while minimizing manufacturing processes thereof.

According to the present invention, the thin film transistor is formed on one substrate and the color filter array is formed on the other substrate. Therefore, the liquid crystal display device of the present invention can be easily fabricated as compared with the conventional liquid crystal display device, in which the thin film transistor and the color filter array are formed on each of two substrates. In addition, since the first and second substrates combined with each other may share the liquid crystal, the image can be bilaterally displayed, so that the thickness of the liquid crystal display device can be reduced while minimizing manufacturing processes of the liquid crystal display device having the bilateral display function.

In addition, the liquid crystal display device according to the present invention can be driven through the FFS or IPS scheme and can be operated with the TN, VVA, MVA or ASV mode.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A liquid crystal display device having a bilateral display function, the liquid crystal display device comprising:
a first substrate including a plurality of first transmissive parts for allowing a first direction incident light to pass therethrough, and a plurality of first reflective parts aligned between the first transmissive parts; and
a second substrate including a plurality of second reflective parts aligned in opposition to the first transmissive parts in order to reflect the first direction incident light, and a plurality of second transmissive parts aligned between the second reflective parts in opposition to the first reflective parts in order to allow a second direction incident light, which has been reflected from the first reflective parts, to pass therethrough.

2. The liquid crystal display device as claimed in claim 1, wherein each of the first and second transmissive parts includes a gate insulation layer and a protective layer, which are sequentially formed on a glass substrate.

3. The liquid crystal display device as claimed in claim 1, wherein each of the first and second reflective parts includes a gate insulation layer formed on a glass substrate, a protective layer formed on the gate insulation layer, a reflective layer formed on the protective layer in order to reflect the light which has passed through the first and second transmissive parts, a color filter resin layer formed on the reflective layer in order to represent one of red, green and blue colors, and a pixel electrode formed on the color filter resin layer.

4. The liquid crystal display device as claimed in claim 1, further comprising a first pad area formed at one side of the first substrate in order to feed a first driving signal to the first substrate and a second pad area formed at one side of the second substrate in order to feed a second driving signal to the second substrate.

5. A liquid crystal display device having a bilateral display function, the liquid crystal display device comprising:
a first substrate including a plurality of first transmissive parts and a plurality of second transmissive parts aligned between the first transmissive parts; and
a second substrate including a plurality of third transmissive parts aligned in opposition to the first transmissive parts in order to allow an incident light, which has passed through the first transmissive parts, to pass therethrough and a plurality of first reflective parts aligned between the third transmissive parts in order to reflect an incident light, which has passed through the second transmissive parts.

6. The liquid crystal display device as claimed in claim 5, wherein each of the first transmissive parts includes a gate insulation layer, a protective layer and a pixel electrode, which are sequentially formed on a glass substrate.

7. The liquid crystal display device as claimed in claim 5, wherein each of the second transmissive parts includes a gate insulation layer and a protective layer, which are sequentially formed on a glass substrate.

8. The liquid crystal display device as claimed in claim 5, wherein each of the third transmissive parts includes a gate insulation layer, a protective layer, and a color filter resin layer, which are sequentially formed on a glass substrate.

9. The liquid crystal display device as claimed in claim 5, wherein each of the first reflective parts includes a gate insulation layer formed on a glass substrate, a protective layer formed on the gate insulation layer, a resin layer formed on the protective layer in such a manner that a cell gap formed between the first reflective part and the second transmissive part is about ½ of a cell gap formed between the first transmissive part and the third transmissive part, a reflective layer formed on the protective layer in order to reflect the light which has passed through the second transmissive parts, a color filter resin layer formed on the reflective layer in order to represent one of red, green and blue colors, and a pixel electrode formed on the color filter resin layer.

10. A liquid crystal display device having a bilateral display function, the liquid crystal display device comprising:
a first substrate formed with a thin film transistor array and including a plurality of first transmissive parts and a plurality of first reflective parts aligned between the first transmissive parts; and a second substrate formed with a color filter array and including a plurality of second reflective parts aligned in opposition to the first transmissive parts and a plurality of second transmissive parts aligned between the second reflective parts in opposition to the first reflective parts,
wherein a first light incident from a first direction passes through the first transmissive parts of the first substrate and is reflected from the second reflective parts of the second substrate in such a manner that the first light is visually detected at a backside of the thin film transistor of the first substrate, and a second light incident from a second opposite direction passes through the second transmissive parts of the second substrate and is reflected from the first reflective parts of the first substrate in such a manner that the second light is visually detected at a backside of the color filter array of the second substrate.

11. The liquid crystal display device as claimed in claim 10, wherein each of the first transmissive parts includes a gate insulation layer, a protective layer, and a pixel electrode, which are sequentially formed on the first substrate, and each of the first reflective parts includes a gate insulation layer, a first reflective plate, a protective layer, and a pixel electrode, which are sequentially formed on the first substrate.

12. The liquid crystal display device as claimed in claim 11, wherein the first reflective plate is patterned on a same layer of a source/drain electrode of the thin film transistor array.

13. The liquid crystal display device as claimed in claim 11, wherein each of the first transmissive parts and the first reflective parts includes a gate insulation layer, a protective layer, and a pixel electrode, which are sequentially formed on the first substrate, the pixel electrode of the first transmissive part is made from a transparent conductive material, and the pixel electrode of the first reflective part is made from an opaque conductive material.

14. The liquid crystal display device as claimed in claim 10, wherein the second transmissive part includes a color filter resin layer and a common electrode, which are sequentially formed on the second substrate, and the second reflective part includes a second reflective plate, a color filter resin layer and a common electrode, which are sequentially formed on the second substrate.

15. The liquid crystal display device as claimed in claim 10, wherein each of the second transmissive parts and the second reflective parts includes a color filter resin layer and a common electrode, which are sequentially formed on the second substrate, the common electrode of the second transmissive part is made from a transparent conductive material, and the common electrode of the second reflective part is made from an opaque conductive material.

16. The liquid crystal display device as claimed in claim 10, wherein a backside of the thin film transistor array of the first substrate and a backside of the color filter array of the second substrate act such that a same image is bilaterally displayed.

17. The liquid crystal display device as claimed in claim 16, wherein a data signal fed into a first data line of the first substrate is identical to a data signal fed into a final data line of the first substrate.

18. The liquid crystal display device as claimed in claim 10, wherein a backside of the thin film transistor array of the first substrate and a backside of the color filter array of the second substrate act such that mutually different images are bilaterally displayed.

19. The liquid crystal display device as claimed in claim 10, further comprising a first light source positioned at a backside of the thin film transistor array of the first substrate, and a second light source positioned at a backside of the color filter array of the second substrate.

20. The liquid crystal display device as claimed in claim 19, wherein the first and second light sources include one selected from the group consisting of an LED, an EEFL and a CCFL.

21. A liquid crystal display device having a bilateral display function, the liquid crystal display device comprising:
a first substrate formed with a thin film transistor array and including a transmissive transistor array for allowing a first directional light to pass therethrough, and a reflective transistor array for reflecting a second directional light incident thereon; and
a second substrate formed with a color filter array and including a reflective color filter array positioned corresponding to the transmissive transistor array in order to reflect the first directional light, which has passed through the transmissive transistor array, and a transmissive color filter array positioned corresponding to the reflective transistor array in order to allow and the light reflected from the reflective transistor array to pass therethrough.

22. The liquid crystal display device as claimed in claim 21, wherein each of the reflective transistors in array is sequentially aligned in column of the first substrate and is alternately positioned with the adjacent transmissive transistor in row of the first substrate, and each of the reflective color filters in array is sequentially aligned in column of the second substrate and is alternately positioned with the adjacent transmissive color filter in row of the second substrate.

23. The liquid crystal display device as claimed in claim 21, wherein each of the reflective transistors is alternately aligned with the adjacent transmissive transistor in column and row of the first substrate and each of the reflective color filters is alternately aligned with the adjacent transmissive color filters in column and row of the second substrate.

24. The liquid crystal display device as claimed in claim 21, wherein the reflective transistor array is aligned in opposition to the transmissive color filter array and the reflective color filter array is aligned in opposition to the transmissive transistor array when the first substrate faces the second substrate.
